(19) United States
(12) Patent Application Publication
(10) Pub. No.: US 2020/0227984 A1
(43) Pub. Date: Jul. 16, 2020

(54) ACTUATOR COIL STRUCTURE AND METHOD FOR MANUFACTURING SAME

(71) Applicant: KBCHEM CO., LTD., Gyeonggi-do (KR)

(72) Inventor: Jong Ik PARK, Seoul (KR)

(21) Appl. No.: 16/630,966

(22) PCT Filed: Jul. 30, 2018
(86) PCT No.: PCT/KR2018/008615

§ 371 Date: Jan. 14, 2020

(30) Foreign Application Priority Data
Jul. 31, 2017 (KR) 10-2017-0096916
Oct. 12, 2017 (KR) 10-2017-0132813

(51) Int. Cl. H02K 15/04; H02K 41/035; H02K 3/26; G03B 13/36; G03B 5/00; C25D 5/02

(52) U.S. Cl. CPC H02K 15/0407; H02K 41/0356; H02K 3/26; G03B 2205/0069; G03B 5/00; C25D 5/022; G03B 2205/0007; G03B 13/36

(57) ABSTRACT

Provided is a method for manufacturing an actuator coil structure including: disposing a base layer including polyimide on a substrate; forming a conductive micro pattern coil on the base layer by a plating process; filling spaces of the micro pattern coil with an insulating layer; and removing the substrate from the base layer by separation to form an actuator coil structure for a camera autofocus or anti-shake function.

### TECHNICAL FIELD

The present invention relates to an actuator coil structure and a method for manufacturing the same, and more particularly, to an actuator coil structure for camera autofocus and anti-shake functions and a method for manufacturing the same.

### BACKGROUND ART

With the development of electronic technology, mobile devices such as smartphones and tablet PCs are becoming popular. Such mobile devices are equipped with a camera module performing a camera function as a basic component. As camera modules used in mobile devices, autofocus camera modules having autofocus functions dedicated to the mobile devices have been developed and widely used for the convenience of photographing. In addition, camera modules used in mobile devices are often provided with anti-shake functions dedicated thereto to improve image quality of obtained images.

### DETAILED DESCRIPTION

### Technical Problem

An object of the present invention is to provide an actuator coil structure for camera autofocus and anti-shake functions and capable of improving image quality of obtained images and reducing manufacturing costs and a method for manufacturing the same. However, these problems are exemplary, and the scope of the present invention is not limited thereto.

### Solution to Problem

It is an aspect of the present invention to provide a method for manufacturing an actuator coil structure for camera autofocus or anti-shake functions to solve the above-described problems.

The method for manufacturing an actuator coil structure includes disposing a base layer including polyimide on a substrate; forming a conductive micro pattern coil on the base layer by a plating process; filling spaces in the micro pattern coil with an insulating layer; and removing the substrate from the base layer by separation to form an actuator coil structure for a camera autofocus or anti-shake function.

In the method for manufacturing the actuator coil structure, the forming of the micro pattern coil may include: forming a plurality of layers of sub-micro pattern coils each extending in a first direction selected from a clockwise direction and a counterclockwise direction; and forming a via pattern vertically connecting the plurality of layers of the sub-micro pattern coils.

In the method for manufacturing the actuator coil structure, each of the sub-micro pattern coils may extend in the first direction while realizing two or more turns, and the plurality of layers of the sub-micro pattern coils extending in the first direction may be integrally connected by the via pattern.

In the method for manufacturing the actuator coil structure, the substrate may be a substrate transmitting UV light and an UV-curable photoreactive polymer layer may be disposed on at least one surface of the base layer, and the separation of the substrate from the base layer may include lowering adhesive strength between the UV-curable photoreactive polymer layer and the substrate by exposing the substrate to UV light.

In the method for manufacturing the actuator coil structure, the disposing of the base layer may include disposing a base layer having a polymer layer formed on at least one surface thereof by a coating process.

In the method for manufacturing the actuator coil structure, the forming of a conductive micro pattern coil on the base layer by a plating process may include: a first step of forming a seed layer on the base layer by a sputtering process, a vacuum deposition process, or an electroless plating process; a second step of forming a photoresist pattern on the seed layer; a third step of forming a conductive micro pattern coil by filling spaces of the photoresist pattern by the electroplating process; a fourth step of removing the photoresist pattern; and a fifth step of removing portions of the seed layer exposed through the spaces of the micro pattern coil.

The method for manufacturing the actuator coil structure may further include forming an additional plated layer on the conductive micro pattern coil by an electroplating process after the fifth step.

It is another aspect of the present invention to provide an actuator coil structure for camera autofocus and anti-shake functions. The actuator coil structure includes: a base layer comprising polyimide; a conductive micro pattern coil formed on the base layer; and an insulating layer filling spaces of the micro pattern coil, wherein the micro pattern coil comprises: a plurality of layers of sub-micro pattern coils, each sub-micro pattern coil extending in a first direction selected from a clockwise direction and a counterclockwise direction; and a via pattern vertically connecting the plurality of layers of the sub-micro pattern coils.

In the actuator coil structure, each of the sub-micro pattern coils may extend in the first direction while realizing two or more turns, and the plurality of layers of the sub-micro pattern coils extending in the first direction may be integrally connected by the via pattern.

In the actuator coil structure, each of the sub-micro pattern coils may have a shape of repeated rectangles with vertically bent edges.

In the actuator coil structure, each of the sub-micro pattern coils may have a shape of repeated polygons with chamfered edges.

### Advantageous Effects

According to an embodiment of the present invention as described above, an actuator coil structure for camera autofocus and anti-shake functions capable of improving image quality of obtained images while reducing manufacturing costs and a method for manufacturing the same may be implemented. However, the scope of the present invention is not limited by these effects.

### BRIEF DESCRIPTION OF DRAWINGS

FIG. 1 is a diagram illustrating a camera module including actuator coils for camera autofocus or anti-shake function.

FIG. 2 is a diagram illustrating an actuator coil structure for the camera autofocus or anti-shake function according to an embodiment of the present invention.

FIGS. 3A to 3O are diagrams sequentially illustrating a process of manufacturing an actuator coil structure according to an embodiment of the present invention.

FIG. 4A is a diagram illustrating layers of a micro pattern coil and a connection structure of a via pattern in an actuator coil structure according to an embodiment of the present invention.

FIG. 4B is a plan view illustrating an overlapping shape of a plurality of layers of the micro pattern coil of FIG. 4A vertically spaced apart from each other.

FIG. 5A is a diagram illustrating layers of a micro pattern coil and a connection structure of a via pattern in an actuator coil structure according to another embodiment of the present invention.

FIG. 5B is a plan view illustrating an overlapping shape of a plurality of layers of the micro pattern coil of FIG. 5A vertically spaced apart from each other.

FIG. 6A is a diagram illustrating a structure including individual coils formed using a rectangular substrate, and FIG. 6B is a diagram illustrating a coil sheet obtained after delamination from the structure illustrated in FIG. 6A.

FIG. 7A is a diagram illustrating a structure including individual coils formed using a wafer substrate, and FIG. 7B is a diagram illustrating a coil sheet obtained after delamination from the structure illustrated in FIG. 7A.

### MODE OF DISCLOSURE

Hereinafter, embodiments of the present invention will be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the concept of the invention to those skilled in the art. In the drawings, thicknesses of layers and regions are exaggerated for clarity.

Throughout the specification, it will also be understood that when an element such as layer, region, or substrate is referred to as being “formed on”, “connected to”, “stacked on” or “coupled with” another element, it can be directly “formed on”, “connected to”, “stacked on” or “coupled to” the other element or intervening elements may be present therebetween. In contrast, when an element is referred to as being “directly formed on”, “directly connected to”, or “directly coupled to” another element, it should be understood that there is no intervening elements therebetween. Like reference numerals refer to like elements. As used herein, the term “and/or” includes any and all combinations of one or more of associated listed items.

Throughout the specification, although the terms “first”, “second”, and the like may be used herein to describe various elements, parts, regions, layers, and/or sections, these elements, parts, regions, layers and/or sections should not be limited by these terms. These terms are only used to distinguish one element, part, region, layer, or section from another element, part, region, layer or section. Thus, a first element, part, region, layer, or section discussed below could be termed a second element, part, region, layer or section without departing from the teachings herein.

Also, spatially relative terms, such as “above” or “upper” and “below” or “lower” and the like, may be used herein for ease of description to describe the relationship of one element to another element(s) as illustrated in the drawings. It will be understood that the spatially relative terms are intended to encompass different orientations of the device in use or operation, in addition to the orientation depicted in the drawings. For example, if a device in the drawings is turned over, elements described as “above” other elements would then be oriented “below” the other elements. Thus, the exemplary term “above” can encompass both an orientation of above and below. The device may be otherwise oriented (rotated 90 degrees or at other orientations) and the spatially relative descriptors used herein interpreted accordingly.

The terms used in the specification are used to describe specific embodiments and are not intended to limit the scope of the present invention. As used herein, an expression used in the singular encompasses the expression of the plural, unless otherwise indicated or it has a clearly different meaning in the context. In addition, as used herein, the terms “comprise” and/or “comprising” are intended to indicate the existence of the shapes, numbers, steps, operations, members, elements, and/or combinations thereof disclosed in the specification, and are not intended to preclude the possibility that one or more other shapes, numbers, steps, operations, members, elements, and/or combinations thereof may exist or may be added.

Hereinafter, embodiments of the present invention will be described with reference to drawings that are schematic illustrations of idealized embodiments. In the drawings, variations in the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing.

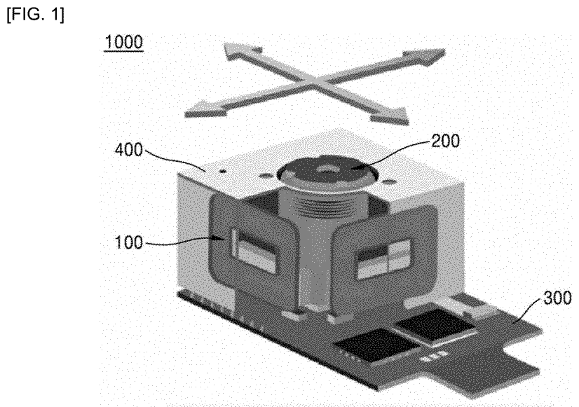

FIG. 1 is a diagram illustrating a camera module including actuator coils for camera autofocus and anti-shake functions.

Referring to FIG. 1, a camera module 1000 includes: a main board 300 mounted with an image device chip; a lens barrel 200 disposed on the main board 300; and a housing 400 surrounding the lens barrel 200. An actuator coil structure 100 for the camera autofocus and anti-shake functions is located adjacent to the lens barrel 200. Hereinafter, an actuator coil structure and a method for manufacturing the same according to an embodiment of the present invention will be described.

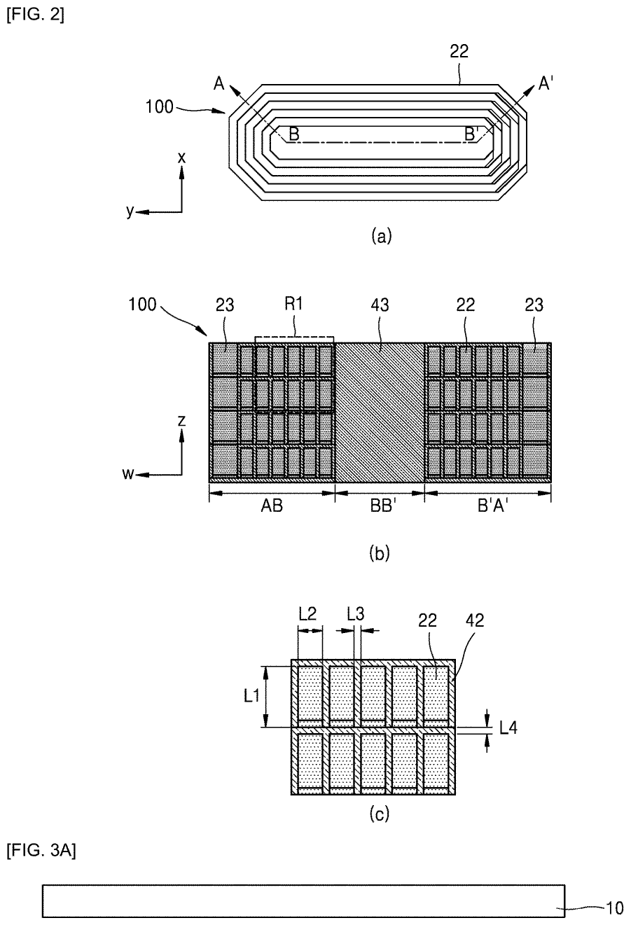

FIG. 2 is a diagram illustrating an actuator coil structure for camera autofocus and anti-shake functions according to an embodiment of the present invention. (A) of FIG. 2 is a plan view illustrating a plurality of layers of a micro pattern coil 22 constituting the actuator coil structure 100 and vertically spaced apart from each other in an overlapping form, (b) of FIG. 2 is a cross-sectional view of the actuator coil structure 100 taken along line A-B-B′-A′ of (a) of FIG. 2, and (c) of FIG. 2 is an enlarged view of an R1 region illustrated in (b) of FIG. 2.

Referring to FIG. 2, for example, four layers of sub-micro pattern coils, which are vertically spaced apart from each other, are arranged. Needless to say, the four layers are exemplary and any plurality of layers may be arranged. Each of the sub-micro pattern coils constituting the micro pattern coil 22 extends in a first direction selected from a clockwise direction and a counterclockwise direction in a connected state to realize one or more turns. In FIG. 2, for example, six turns are realized. Meanwhile, the sub-micro pattern coil of each layer is arranged such that adjacent portions of the extending sub-micro pattern coil are horizontally spaced apart from each other without being in contact therewith during the process of extending in the first direction by a plurality of turns. Although not shown in the drawing, a via pattern that vertically connects the sub-micro pattern coils of adjacent layers is introduced. Spaces of the micro pattern coil 22 may be filled with an insulating layer 42.

Specifically, the present inventors adjust a height L1 and a width L2 of the sub-micro pattern coil of each layer to about 50 μm and 25 μm, respectively, by an electroplating process and adjust a distance L3 of horizontal spaces of the sub-micro pattern coil of each layer to about 5 μm and a distance L4 of vertical spaces between the sub-micro pattern coils of the plurality of layers to about 10 μm. When these numeric values are measured, the sub-micro pattern coils including a seed layer which will be described later are measured.

In this structure, an induced magnetic field may be generated while a current flows into a sub-micro pattern coil located in an uppermost layer (or lowermost layer) among the plurality of layers of the micro pattern coil 22 and flows out from a sub-micro pattern coil located in the lowermost layer (or the uppermost layer). The generated induced magnetic field may adjust the position of the camera lens structure located adjacent to the actuator coil structure 100 and the camera autofocus and anti-shake functions may be performed by adjusting the position of the camera lens structure.

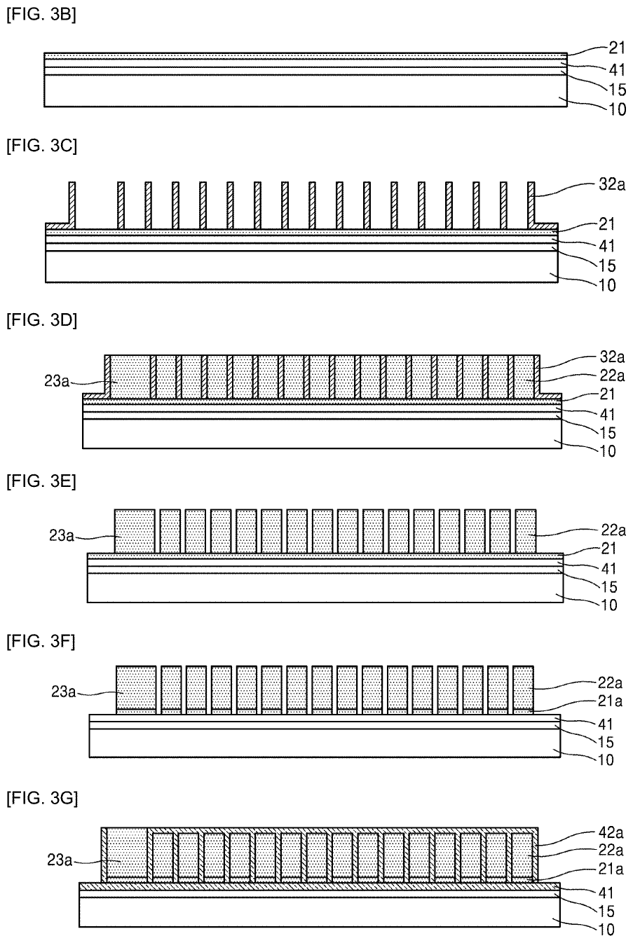

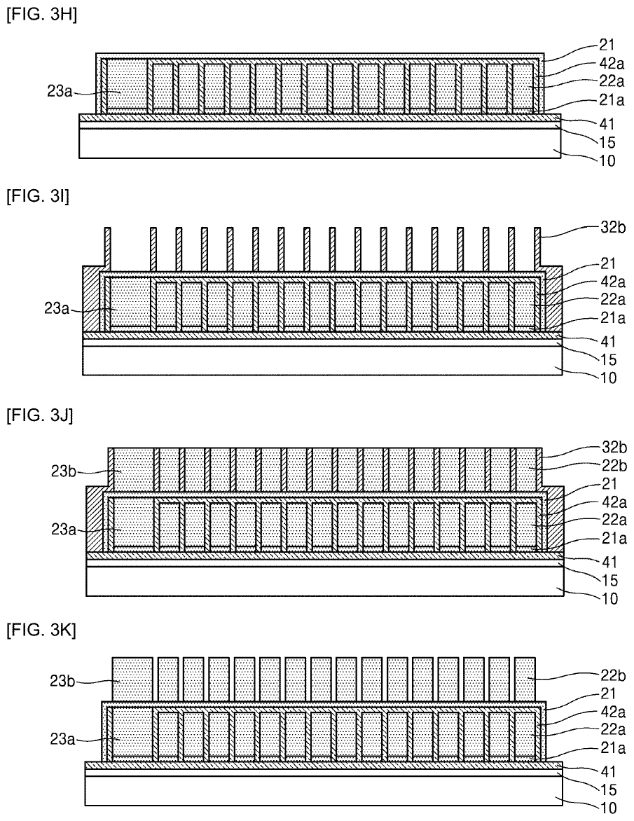

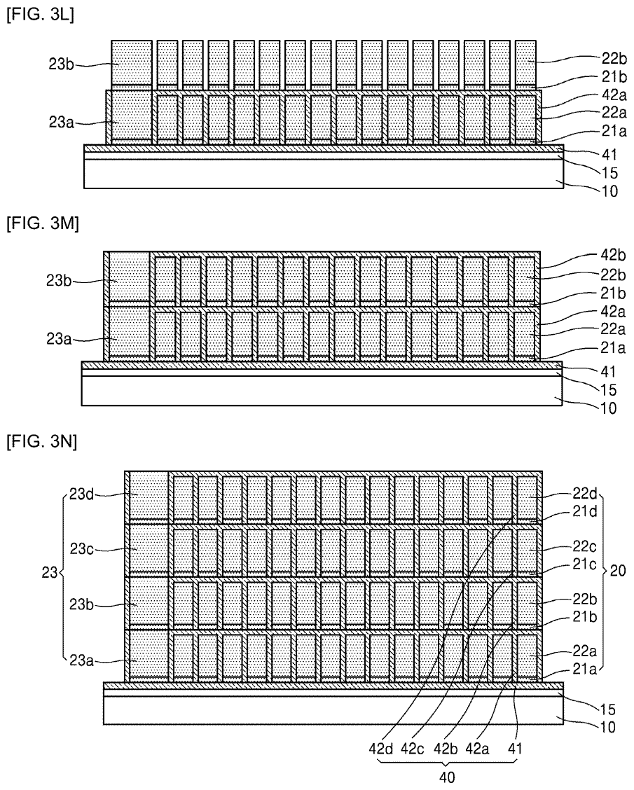

FIGS. 3A to 3P are diagrams sequentially illustrating a process of manufacturing an actuator coil structure according to an embodiment of the present invention.

Referring to FIGS. 3A and 3B, the substrate 10 may include a substrate transmitting UV light such as a glass or sapphire substrate. A base layer 41 including polyimide is located on the substrate 10. Furthermore, an UV-curable photoreactive polymer layer 15 may be located on at least one surface of the base layer 41. The base layer 41 may have a thickness of, for example, 5 μm to 200 μm.

The UV-curable photoreactive polymer layer 15 may be formed on at least one surface of the base layer 41 by a coating process. When the UV-curable photoreactive polymer layer 15 is exposed to UV light, adhesive strength between the substrate 10 and the UV-curable photoreactive polymer layer 15 decreases, resulting in separation of the substrate 10 from the base layer 41.

For example, a polyimide UV tape coated with an UV-curable photoreactive polymer layer may be laminated on a surface in contact with the substrate. Alternatively, after laminating an UV tape, both surfaces of which are coated with UV-curable photoreactive polymer layers, on the surface, a polyimide film may be laminated thereon continuously.

Subsequently, a seed layer 21 for copper (Cu) electroplating may be formed on the base layer 41 including polyimide. The seed layer 21 may be formed by a sputtering process, a vacuum deposition process, or an electroless plating process. When the sputtering process or the vacuum deposition process is applied thereto, the seed layer 21 for Cu electroplating may include a Ti/Cu continuous layer or a NiCr/Cu continuous layer.

Referring to FIG. 3C, a photoresist pattern 32a is formed on the seed layer 21. For example, the photoresist pattern 32a may have a thickness of 1 μm to 100 μm. Specifically, the photoresist pattern 32a may have a thickness of 50 μm. The photoresist pattern 32a may have spaces each having a distance of 1 μm to 50 μm. The photoresist pattern 32a may have a width of 1 μm to 20 μm.

Referring to FIG. 3D, a conductive first sub-micro pattern coil 22a is formed on the seed layer 21 by a Cu electroplating process. Since the first sub-micro pattern coil 22a is formed in the empty spaces of the photoresist pattern 32a, the width, thickness, and space distance of the first sub-micro pattern coil 22a are linked to the space distance, thickness, and width of the photoresist pattern 32a, respectively. For example, the first sub-micro pattern coil 22a as a plated layer may have a thickness of 1 μm to 100 μm. Specifically, the first sub-micro pattern coil 22a may have a thickness of 50 μm. Meanwhile, although the cross-sectional view shows that the first sub-micro pattern coil 22a is formed with wires horizontally spaced apart from each other, it is described above that the conductive first sub-micro pattern coil 22a is actually integrally connected by realizing a plurality of turns (for example, 15 turns in FIG. 3D). Meanwhile, a first electrode connector 23a is formed at one end of the first sub-micro pattern coil 22a by a Cu electroplating process.

Referring to FIG. 3E, after forming the first sub-micro pattern coil 22a as a plated layer and the first electrode connector 23a, the photoresist pattern 32a is removed.

Referring to FIG. 3F, portions of the seed layer 21 exposed through the spaces of the first sub-micro pattern coil 22a are removed to form a first seed layer pattern 21a. For example, portions of the Cu seed layer 21 may be removed by using a Cu etching solution. When a width of the Cu plated layer is less than a reference value after removing the portions of the seed layer 21, an electroplating process may further be performed by an insufficient width to form an additional plated layer on the conductive first sub-micro pattern coil 22a.

Referring to FIG. 3G, a first insulating layer 42a that fills spaces horizontally formed in the first seed layer pattern 21a and the first sub-micro pattern coil 22a is formed. A material used to form the insulating layer may include a photoresist or polyimide. After coating the insulating layer, the first electrode connector 23a may be open by an exposure process. After forming the insulating layer, curing may be performed at a low temperature (<180° C.) by UV radiation or electron beams.

Referring to FIG. 3H, a second seed layer 21 for Cu plating is formed on the first insulating layer 42a and the first electrode connector 23a.

Referring to FIG. 3I, a second photoresist pattern 32b is formed on the second seed layer 21. For example, the second photoresist pattern 32b may have a thickness of 1 μm to 100 μm. Specifically, the second photoresist pattern 32b may have a thickness of 50 μm. The second photoresist pattern 32b may have spaces each having a distance of 1 μm to 50 μm. The second photoresist pattern 32b may have a width of 1 μm to 20 μm.

Referring to FIG. 3J, a conductive second sub-micro pattern coil 22b is formed on the second seed layer 21 by performing a Cu electroplating process. Since the second sub-micro pattern coil 22b is formed in the empty spaces of the second photoresist pattern 32b, the width, thickness, and space distance of the second sub-micro pattern coils 22b are linked to the space distance, thickness, and width of the second photoresist pattern 32b. For example, the second sub-micro pattern coil 22b as a plated layer may have a thickness of 1 μm to 100 μm. Specifically, the second sub-micro pattern coil 22b may have a thickness of 50 μm. Meanwhile, although the cross-sectional view shows that the second sub-micro pattern coil 22b is formed with horizontal spaces, it is described above that the second sub-micro pattern coil 22b is actually integrally connected by realizing by a plurality of turns (for example, 15 turns in FIG. 3J). Meanwhile, a second electrode connector 23b is formed at one end of the second sub-micro pattern coil 22b by a Cu electroplating process.

Referring to FIG. 3K, after forming the second sub-micro pattern coil 22b as a plated layer and the second electrode connector 23b, the second photoresist pattern 32b is removed.

Referring to FIG. 3L, portions of the second seed layer 21 exposed through spaces of the second sub-micro pattern coil 22b are removed to form a second seed layer pattern 21b. For example, portions of the Cu seed layer 21 may be removed by using a Cu etching solution. When a width of the Cu plated layer is less than a reference value after the portions of the seed layer 21 are removed, an electroplating process may further be performed by an insufficient width to form an additional plated layer on the conductive second sub-micro pattern coil 22b.

Referring to FIG. 3M, a second insulating layer 42b that fills spaces horizontally arranged in the second seed layer pattern 21b and the second sub-micro pattern coil 22b is formed. A material used to form the insulating layer may include a photoresist or polyimide. After coating the insulating layer, the second electrode connector 23b may be open by an exposure process. After forming the insulating layer, curing may be performed at a low temperature (<180° C.) by UV radiation or electron beams.

Referring to FIG. 3N, a conductive coil 20 is realized by forming the seed layer and the micro pattern coils by repeating the above-described process. Specifically, the seed layer is configured by sequentially arranging the first seed layer 21a, the second seed layer 21b, a third seed layer 21c, and a fourth seed layer 21d, and the micro pattern coil is configured by sequentially arranging the first sub-micro pattern coil 22a, the second sub-micro pattern coil 22b, a third sub-micro pattern coil 22c, and a fourth sub-micro pattern coil 22d. Meanwhile, the electrode connector 23 is configured by sequentially arranging the first electrode connector 23a, the second electrode connector 23b, a third electrode connector 23c, and a fourth electrode connector 23d.

Each of the layers constituting the conductive coil 20 is electrically insulated by the insulating layer. For example, the first sub-micro pattern coil 22a of a first layer and the second seed layer 21b of a second layer are electrically insulated by an insulating layer, and the second sub-micro pattern coil 22b of the second layer and the third seed layer 21c of a third layer are electrically insulated by an insulating layer. Specifically, an insulating layer 40 is configured by sequentially arranging the base layer 41, the first insulating layer 42a, the second insulating layer 42b, a third insulating layer 42c, and a fourth insulating layer 42d.

Meanwhile, each of the layers constituting the electrode connector 23 are in contact with each other to be electrically connected. For example, the first electrode connector 23a of the first layer and the second seed layer 21b of the second layer are in contact with and electrically connected to each other. The second electrode connector 23b of the second layer and the third seed layer 21c of the third layer are in contact with and electrically connected to each other.

Referring to FIG. 3O, the substrate 10 is separated and removed from the base layer 41. When the substrate 10 is a substrate transmitting UV light and the UV-curable photoreactive polymer layer 15 is located on at least one surface of the base layer 41, the substrate 10 may be separated from the base layer 41 by using a phenomenon that the adhesive strength between the UV-curable photoreactive polymer layer 15 and the substrate 10 decreases when the substrate 10 is exposed to UV light.

However, the separating process of the substrate 10 from the base layer 41 according to the technical idea of the present invention is not limited thereto, and any other examples may also be available. For example, the substrate 10 may be separated from the base layer 41 by emitting laser beams to an interface between the substrate 10 and the base layer 41 without introducing the UV-curable photoreactive polymer layer 15 thereto.

Referring to FIG. 3P, the actuator coil structure 100 for a camera autofocus or anti-shake function implemented by performing the above-described steps is illustrated. In the actuator coil structure 100, conductive coils 20 realizing a plurality of turns are located on both sides of a central region 43, and the electrode connectors 23 are located at both ends. The structures illustrated in FIGS. 3A to 3O correspond to a structure illustrated on the left of FIG. 3P.

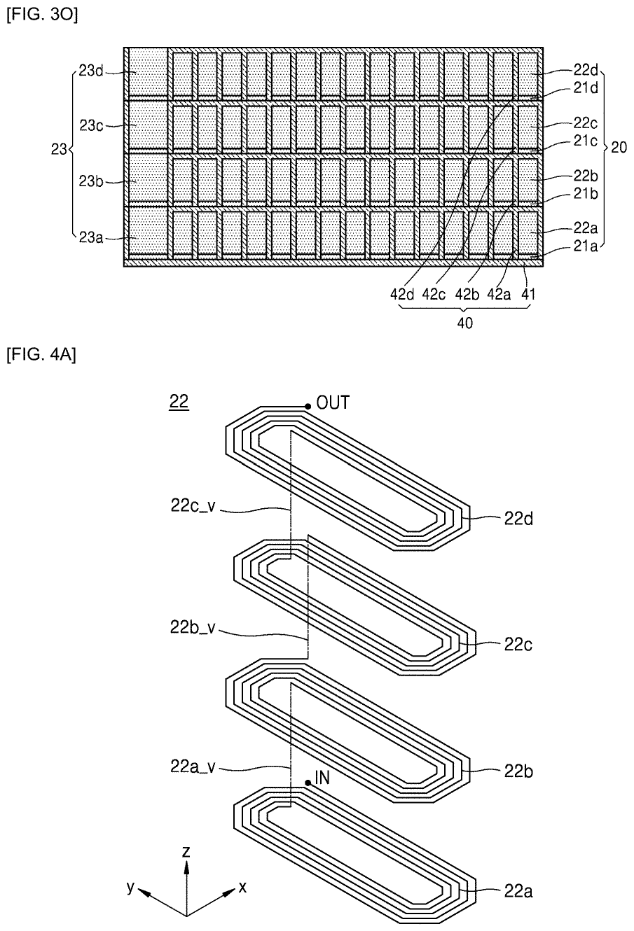

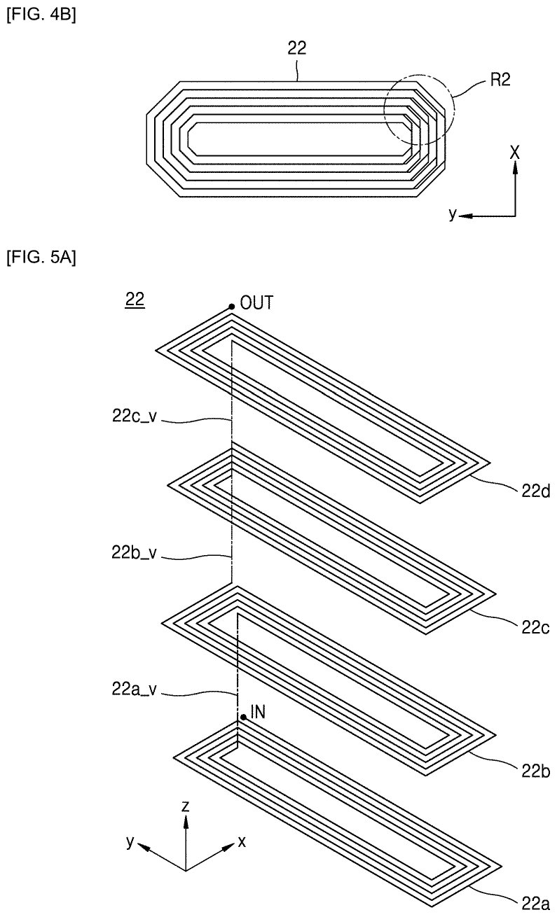

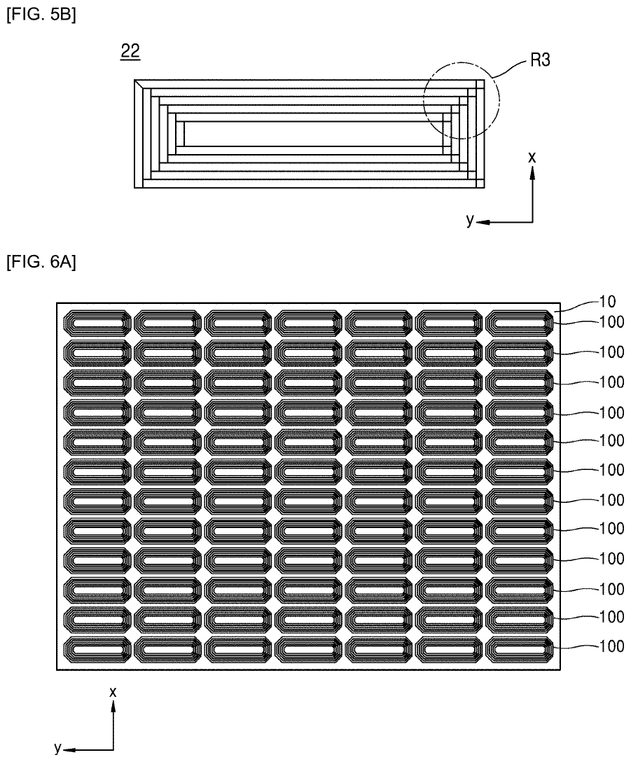

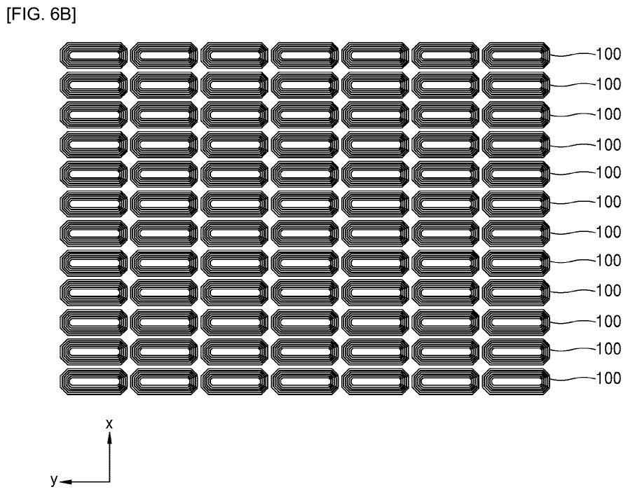

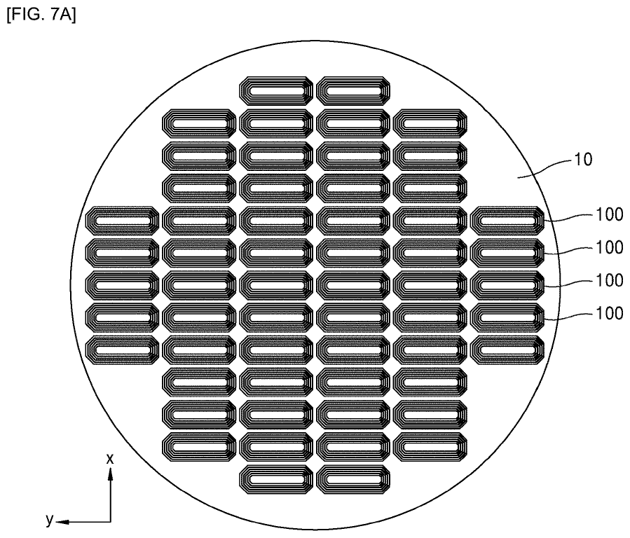

FIGS. 4A and 5A are diagrams illustrating the layers of the micro pattern coils and connection structures of the via patterns vertically connecting the micro pattern coils in the actuator coil structures according to various embodiments of the present invention, and FIGS. 4B and 5B are plan views illustrating overlapping shapes of the plurality of layers of the micro pattern coils of FIGS. 4A and 5A vertically spaced apart from each other.

Referring to FIGS. 4A and 5A, the first sub-micro pattern coil 22a, the second sub-micro pattern coil 22b, the third sub-micro pattern coil 22c, and the fourth sub-micro pattern coil 22d are vertically spaced apart from each other and vertically connected to each other by a first via pattern 22a_v, a second via pattern 22b_v, and a third via pattern 22c_v, respectively.

Specifically, an input terminal IN is disposed at an outer end of the first sub-micro pattern coil 22a, and an inner end of the first sub-micro pattern coil 22a extending from the outer end of the first sub-micro pattern coil 22a in the clockwise direction is connected to an inner end of the second sub-micro pattern coil 22b by the first via pattern 22a_v. Successively, an outer end of the conductive second sub-micro pattern coil 22b extending from the inner end of the conductive second sub-micro pattern coil 22b in the clockwise direction is connected to an outer end of the third sub-micro pattern coil 22c by the second via pattern 22b_v. Successively, an inner end of the third sub-micro pattern coil 22c extending from the outer end of the third sub-micro pattern coil 22c in the clockwise direction is connected to an inner end of the fourth sub-micro pattern coil 22d by the third via pattern 22c_v. Successively, an outer terminal OUT is disposed at an outer end of the fourth sub-micro pattern coil 22d extending from the inner end of the fourth sub-micro pattern coil 22d in the clockwise direction.

According to this structure, the arrangement of the via patterns connecting vertically adjacent sub-micro pattern coils may sequentially include a connection arrangement from the inner side of the lower sub-micro pattern coil to the inner side of the upper sub-micro pattern coil, a connection arrangement from the outer side of the lower sub-micro pattern coil to the outer side of the upper sub-micro pattern coil, and a connection arrangement from the inner side of the lower sub-micro pattern coil to the inner side of the upper sub-micro pattern coil. Introduction of such an alternating connection arrangement of the via patterns may be advantageous in that an overlapping cross-sectional area of the plurality of layers of the micro pattern coil vertically spaced apart from each other may be minimized.

Also, according to this structure, an induced magnetic field may be generated while a current flows into the input terminal IN of the first sub-micro pattern coil 22a located in the lowermost layer and flows out of the output terminal OUT of the fourth sub-micro pattern coil 22d located in the upper most layer among the plurality of layers of the micro pattern coil 22. Since the current flows in the same direction, i.e., in the clockwise direction, in each of the sub-micro pattern coils, the magnitude of the generated induced magnetic field is amplified. The generated induced magnetic field having an amplified magnitude may effectively adjust the position of the camera lens structure located nearby and perform the camera autofocus and anti-shake functions by adjusting the position of the camera lens structure.

Referring to FIG. 4B, each sub-micro pattern coil has a shape with repeated polygons with chamfered edge regions R2. On the contrary, referring to FIG. 5B, each sub-micro pattern coil has a shape of repeated rectangles with vertically bent edge regions R3.

First, according to the structure shown in FIG. 4B, the input terminal, the output terminal, or the like may easily be arranged since the cross-sectional area of the sub-micro pattern coil is relatively small, and electrical resistance is small since the length of the sub-micro pattern coil is relatively short. Meanwhile, according to the structure shown in FIG. 5B, the magnitude of the generated induced magnetic field is greater due to a greater length of the sub-micro pattern coil in the lengthwise direction (parallel to the Y-axis).

FIG. 6A is a diagram illustrating a structure including individual coils formed using a rectangular substrate, and FIG. 6B is a diagram illustrating a coil sheet obtained after delamination from the structure illustrated in FIG. 6A. This embodiment corresponds to a case in which a rectangular substrate is used as the substrate in the method for manufacturing an actuator coil structure described above with reference to FIGS. 3A to 3O. The coil sheet is formed by arraying the plurality of actuator coil structures 100 described above, and each of the actuator coil structure 100 obtained by individualization may be applied to a product.

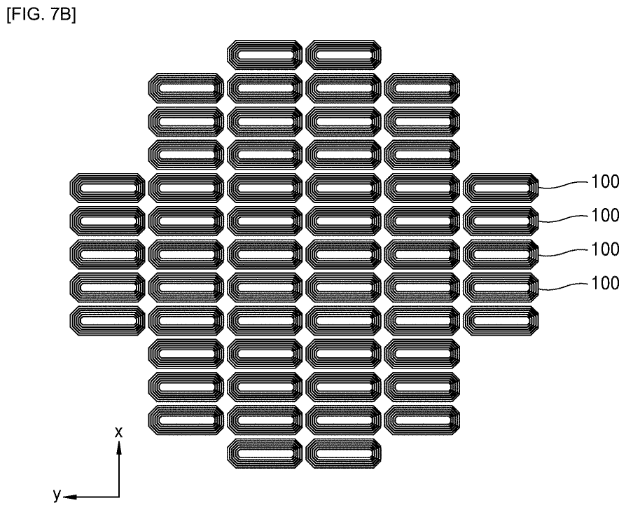

FIG. 7A is a diagram illustrating a structure including individual coils formed using a wafer substrate, and FIG. 7B is a diagram illustrating a coil sheet obtained after delamination from the structure illustrated in FIG. 7A. This embodiment corresponds to a case in which a wafer substrate is used as the substrate 10 in the method for manufacturing an actuator coil structure described above with reference to FIGS. 3A to 3O. The coil sheet is formed by arraying the plurality of actuator coil structures 100 described above, and each of the actuator coil structures 100 obtained by individualization may be applied to a product.

In the actuator coil for camera autofocus and anti-shake functions and the method for manufacturing the same according to the present invention described above, image quality of obtained images may be improved while reducing manufacturing costs by optimization of the plated seed layer, filling and curing a photoresist, planarization of a filled layer, light exposure and plating of a structure with a high aspect ratio, continuous laminating of an UV film and a polyimide layer, delamination techniques, and the like.

Table 1 shows comparison results of technology and quality competitiveness between products according to the embodiment of the present invention (micro pattern coil) and products according to a comparative example (fine pattern-coil (FP-Coil)). The FP-Coil method is one of the methods of manufacturing printed circuit boards (PCBs). According to the actuator coil structure for and anti-shake functions and the method for manufacturing the same according to the embodiment of the present invention, the yield may be improved by a semiconductor-PCB fusion method when compared with the comparative example, and an assembly yield may be improved by an SMT process when compared to wound coils. Furthermore, the technical idea of the present invention may also be applied to high-efficiency charging coils for wireless chargers, wound inductors, antennas, and the like.

TABLE 1

| | | | |
|---|---|---|---|
| | Example | Comparative | |
| | (micro | Example | |
| Item | pattern coil) | (FP-Coil) | Evaluation |

| | | | | | |
|---|---|---|---|---|---|
| Line Width | 25 | μm | 27~70 | μm | — |
| Line Space | <10 | μm | 15~60 | μm | The narrower, |
| | | | | | the better |
| Line Height | 50 | μm | 41 | μm | — |

| | | | |
|---|---|---|---|
| Number of | 2~8 | 2, 6 | — |
| Layers | | | |

| | | | | | |
|---|---|---|---|---|---|
| Layer Gap | <7 | μm | >60 | μm | The narrower, |
| | | | | | the better |
| Outline Margin | <50 | μm | >120 | μm | The narrower, |
| | | | | | the better |
| Magnet-coil | <200 | μm | <150 | μm | The bigger, |
| gap | | | | | the better |

| | | | |
|---|---|---|---|
| Foreign matter | Excellent | Excellent | — |

While exemplary embodiments have been shown and described above, it will be apparent to those skilled in the art that modifications and variations could be made without departing from the scope of the present invention as defined by the appended claims.

1. A method for manufacturing an actuator coil structure, the method comprising:
disposing a base layer on a substrate, the base layer including polyimide;
forming a conductive micro pattern coil on the base layer by a plating process;
filling spaces between turns of the micro pattern coil with an insulating layer; and
forming an actuator coil structure for a camera autofocus or anti-shake function by removing the substrate from the base layer.

2. The method of claim 1, wherein the forming of the micro pattern coil comprises:
forming a plurality of layers of sub-micro pattern coils each extending in a first direction selected from a clockwise direction and a counterclockwise direction; and
forming a via pattern vertically connecting the plurality of layers of the sub-micro pattern coils.

3. The method of claim 2, wherein each of the sub-micro pattern coils extends in the first direction while realizing two or more turns, and the plurality of layers of the sub-micro pattern coils extending in the first direction are integrally connected by the via pattern.

4. The method of claim 1, wherein the substrate is a substrate transmitting UV light and an UV-curable photoreactive polymer layer is disposed on at least one surface of the base layer, and
the separation of the substrate from the base layer comprises lowering adhesive strength between the UV-curable photoreactive polymer layer and the substrate by exposing the substrate to UV light.

5. The method of claim 4, wherein the disposing of the base layer comprises disposing a base layer having a polymer layer formed on at least one surface thereof by a coating process.

6. The method of claim 1, wherein the forming of a conductive micro pattern coil on the base layer by a plating process comprises:
a first step of forming a seed layer on the base layer by a sputtering process, a vacuum deposition process, or an electroless plating process;
a second step of forming a photoresist pattern on the seed layer;
a third step of forming a conductive micro pattern coil by filling spaces between the photoresist patterns by the electroplating process;
a fourth step of removing the photoresist pattern; and
a fifth step of removing portions of the seed layer exposed through the spaces between turns of the micro pattern coil.

7. The method of claim 6, further comprising forming an additional plated layer on the conductive micro pattern coil by an electroplating process after the fifth step.

8. An actuator coil structure comprising:
a base layer comprising polyimide;
a conductive micro pattern coil on the base layer; and
an insulating layer that fills spaces between turns of the micro pattern coil,
wherein the micro pattern coil comprises: a plurality of layers of sub-micro pattern coils, each sub-micro pattern coil extending in a first direction, the first direction being selected from a clockwise direction and a counterclockwise direction; and a via pattern vertically connecting the plurality of layers of the sub-micro pattern coils.

9. The actuator coil structure of claim 8, wherein each of the sub-micro pattern coils extends in the first direction and the number of turns of which is two or more, and the plurality of layers of the sub-micro pattern coils extending in the first direction are integrally connected by the via pattern.

10. The actuator coil structure of claim 9, wherein each of the sub-micro pattern coils has a shape of repeated rectangles with vertically bent edges.

11. The actuator coil structure of claim 9, wherein each of the sub-micro pattern coils has a shape of repeated polygons with chamfered edges.
